(19) United States
(12) Patent Application Publication
(10) Pub. No.: US 2003/0182401 A1
(43) Pub. Date: Sep. 25, 2003

(54) URL information sharing system using proxy cache of proxy log

(75) Inventor: Kazuhiro Moriya, Kawasaki-Shi (JP)

Correspondence Address: Richard P. Berg, Esq., c/o LADAS & PARRY, Suite 2100, 5670 Wilshire Boulevard, Los Angeles, CA, 90036-5679, US

(73) Assignee: ALPS SYSTEM INTEGRATION CO., LTD.

(21) Appl. No.: 10/393,624

(22) Filed: Mar. 21, 2003

(30) Foreign Application Priority Data
Mar. 25, 2002 (JP) 2002-82319

(51) Int. Cl. G06F 15/16

(52) U.S. Cl. 709/219

(57) ABSTRACT

There is provided a URL information sharing system capable of controlling a cache or a log every arbitrary client group, sharing URL information by automatically generating a URL link collection needed in the group, and conducting self-imposed control on reading of information causing a harmful influence. The URL information sharing system includes registration means for registering group configuration information which indicates association relations between cache or log control MEANS group in the proxy server and client terminals or terminal users, group-classified cache/log control means for controlling a URL information cache or log with respect to the web site every group on the basis of the group configuration information, link collection generation means for generating a URL link collection every group by the use of cache information or log information, and link collection display means for displaying the link collection generated every group so that respective clients or a specific client of the group may use the link collection.

### BACKGROUND OF THE INVENTION

1. Field of the Invention

The present invention relates to a computer system in which a client terminal connected to an internal network accesses a web site on the Internet via a proxy server having a cache function. In particular, the present invention relates to a system in which it is made possible to control a cache or a log every arbitrary client group.

2. Description of the Related Art

As a conventional server for relaying access to the Internet, there is a server having a data cache function. The so-called cache server is adapted to store a copy of data managed by a server, such as a web server, and provide data rapidly instead of a server accessed by the user. For example, in a proxy server connected between a LAN (local area network) in an organization such as an enterprise and a communication network such as the Internet, a web page referred to by someone in the organization is stored for a fixed period of time. When a different user accesses the same page, the web page on the cache server is sent.

### SUMMARY OF THE INVENTION

In the conventional server having the above-described cache function, caching is conducted by taking all client terminals connected to an internal network, such as a LAN, as subjects. It is impossible to control the cache every arbitrary client group and control the cache every user group of client terminals. Conventionally, cache information in a proxy server that conducts relaying for the Internet is used only for making the connection environment of the Internet efficient, and there are no other utilization methods. As for access history information (hereinafter referred to as proxy log or log information) of a web page stored on a recording medium of a proxy server as well, there are no one which controls logs every arbitrary client group or which can control logs every user group of client terminals in the same way as a proxy cache. Furthermore, since there is also a problem of an infringement of privacy, the application is also limited.

In view of the circumstances described above, the present invention has been made. An object of the present invention is to provide a URL (Uniform Resource Locators) information sharing system capable of controlling a cache or a log every arbitrary client group. Another object of the present invention is to provide a URL information sharing system capable of sharing URL information by automatically generating a URL link collection needed in the group and of conducting self-imposed control on reading of information causing a harmful influence.

In a system in which a client terminal connected to an internal network accesses a web site on the Internet via a proxy server having a cache function, the present invention is achieved by a URL information sharing system using proxy cache or proxy log, including: registration means for registering group configuration information which indicates association relations between cache or log control MEANS group in the proxy server and client terminals or terminal users, with respect to client terminals connected to the internal network; and group-classified cache/log control means for controlling a URL information cache or log with respect to the web site every group on the basis of the group configuration information.

In addition, the present invention is achieved more efficiently by a URL information sharing system further including link collection generation means for generating a URL link collection every group by the use of cache information or log information created every group, and link collection display means for displaying the link collection generated every group so that respective clients or a specific client of the group may use the link collection; further including a web server for opening the URL link collection of each group to the public by the use of the link collection display means, wherein information of the URL link collection can be shared by respective client terminals via the web server; wherein URL link information pieces are arranged in order of decreasing number of times of use in the group and the URL link collection is displayed; and wherein the link collection display means displays a users' list showing a list of users who have utilized the URL, as additional information.

In addition, the present invention is achieved more efficiently by a URL information sharing system further including: a database for storing a URL information group obtained by sorting URL information of each web site on the Internet according to predetermined categories, and cache/log information sorting means for sorting cache information or log information created for each group, according to the categories; wherein the link collection display means displays the URL link collection of the group from category to category, wherein in the case of a registration form in which association relation with the group is registered by means of the terminal user, registration is conducted by the use of a user account that indicates the terminal user; and wherein the URL link collection generation means generates the URL link collection by adding access information that indicates when, how many times, who has accessed the URL for reading, and the link collection display means displays the access information so as to be able to be read from respective clients or a specific client of the group.

### BRIEF DESCRIPTION OF THE DRAWINGS

FIG. 1 is a schematic diagram showing an example of a whole configuration of a URL information sharing system using a proxy cache according to the present invention;

FIG. 2 is a block diagram showing a configuration example of a principal part of the URL information sharing system according to the present invention;

FIG. 3 is a schematic diagram showing processing of the URL information sharing system according to the present invention;

FIGS. 4A and 4B are diagrams showing a first display example (in the case of Japanese) of a URL link collection every group in the present invention;

FIG. 5 is a diagram showing a second display example of (in the case of Japanese) the URL link collection in each group in the present invention;

FIG. 6 is a schematic diagram showing another example of a whole configuration of the URL information sharing system according to the present invention;

FIG. 7 is a block diagram showing a configuration example of a principal part of the URL information sharing system shown in FIG. 6; and

FIG. 8 is a schematic diagram showing processing of the URL information sharing system shown in FIG. 6.

### DESCRIPTION OF THE PREFERRED EMBODIMENTS

Hereinafter, preferred embodiments of the present invention will be described in detail with reference to the drawings.

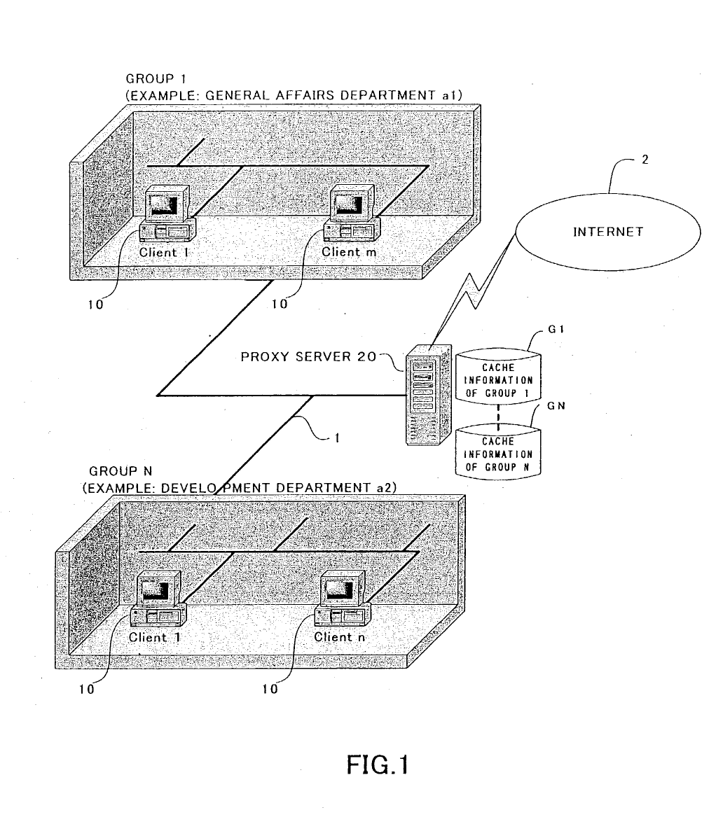

FIG. 1 schematically shows an example of a whole configuration of a URL information sharing system using a proxy cache according to the present invention. In a form widely adopted in the case where access to the Internet from each personal computer is made possible in an organization such as an enterprise, for example, a proxy server 20 having a security function and a cache function is connected between a LAN 1 and the Internet 2 as shown in FIG. 1 and each client terminal 10 (hereinafter referred to as client), such as a personal computer, accesses the Internet 2 via the proxy server 20.

In general, the proxy server conducts cache control on all relay data of clients 10 connected to an internal network, such as an in-plant network or an intranet. In a proxy server 20 according to the present invention, clients 10 connected to an internal network, such as the LAN 1, are grouped in specific groups 1 to N, such as a general affairs department a1 and a development department a2, and the cache control of the data (hereinafter referred to as cache information) is conducted for each of groups 1 to N. Furthermore, by the use of cache information G1 to GN created respectively for the groups 1 to N, a URL link collection for sharing information is automatically generated, and the generated URL link collection is opened to public via, for example, a local web server (a web server connected to the internal network), so that clients 10 in the group or intergroup clients 10 may share information.

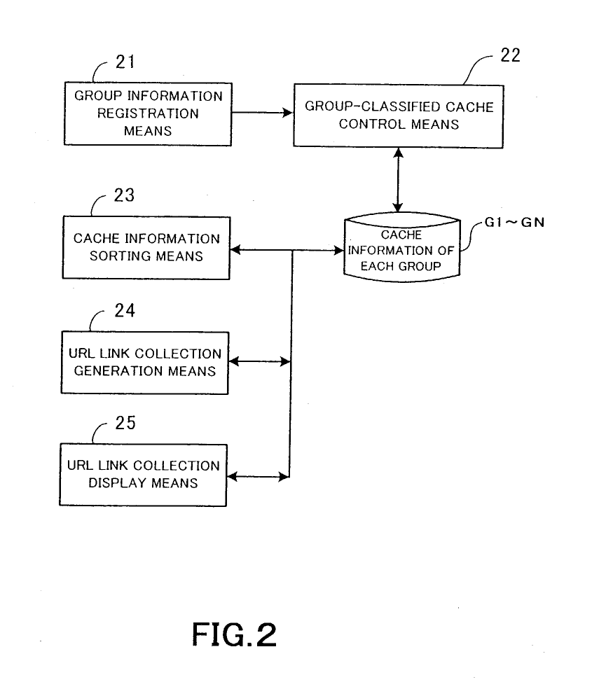

FIG. 2 shows a configuration example of a principal part of the URL information sharing system according to the present invention in a block diagram form. The URL information sharing system includes group information registration means 21 for registering group configuration information which indicates association relations between cache control MEANS group in the proxy server and client terminals or terminal users, with respect to client terminals connected to an internal network such as a LAN, group-classified cache control means 22 for generating and controlling a URL information cache with respect to a web site every group on the basis of the registered group configuration information, cache information sorting means 23 for sorting cache information created every group into preset predetermined categories (information types), URL link collection generation means 24 for automatically generating a URL link collection (hereinafter simply referred to as link collection) for sharing information, every group by the use of cache information created every group, and URL link collection display means 25 for displaying the link collection so that respective clients or a specific client of the group may use the link collection and URL information may be shared every group. By the way, at least the group-classified cache control means 22 among the respective means 21 to 25 is included in the proxy server 20. The URL link collection display means 25 is preferably included in a web server connected to the internal network such as the LAN 1. Other means may be included either on the client side or in other computers.

As methods for grouping cache information, there are (a) a method of registering identifiers (for example, IP addresses) specifying individual clients in the proxy server 20 and grouping them, (b) a method of registering ranges of identifiers (for example, IP addresses) specifying individual clients in the proxy server 20 and grouping them, and (c) a method of registering identifiers (for example, user accounts) specifying users of individual clients in the proxy server 20, grouping them, and making possible cache control of each user group.

The group information registration means 21 in the proxy server 20 designates arbitrary clients (or users) in a client group (or its user group) as clients belonging to the group by the use of one of the methods (a) to (c), and registers group configuration information, which indicates association between clients and the group. In the example shown in FIG. 1, clients 1 to m of the general affairs department a1 are registered as group 1 and clients 1 to n of the development department a2 are registered as group N. The group-classified cache control means 22 determines which group the client (terminal or user) belongs to on the basis of the registered group configuration information, and controls caches for each of the groups 1 to N. Cache regions of the groups 1 to N are assigned to the groups and used. However, the size of the region of each group may be altered dynamically and one cache region may be shared by groups. By the way, the cache control in the proxy server 20 is equivalent to the conventional control method having the hit rate, date and time of update, storage time on the cache, data size, and type of cache medium as elements, and description thereof will be omitted.

Cache information stored in a storage medium, such as a cache memory in the proxy server 20 includes information, such as the URL information, time, hit rate, and data size. The URL link collection generation means 24 analyzes inclination of utilized sites of the Internet used in the group and access tendency of respective users on the basis of, for example, information, such as the time, hit rate and users, contained in the cache information, and generates a URL link collection reflecting the analysis result. The “analysis result” referred herein is an analysis result of utilized situation of each URL, such as the number of accesses of URL and when, how many times, who has accessed the URL. These analysis results are added to address information of URL and recorded on a recording medium such as a web server so as to be able to be referred to from respective clients or a specific client for manager of the group.

In this way, caches are controlled every client group. If the group is, for example, a technical division, therefore, then, a large number of URLs in the field needed in the technique division are cached and a link collection to web pages utilized in the group is automatically created. Therefore, it becomes possible to promptly know information needed in the division. Furthermore, by opening the cache information to public internally as a link collection, it is possible to suppress reading of URLs that have no relation to the job.

The function of automatically generating link collections classified by categories will now be described.

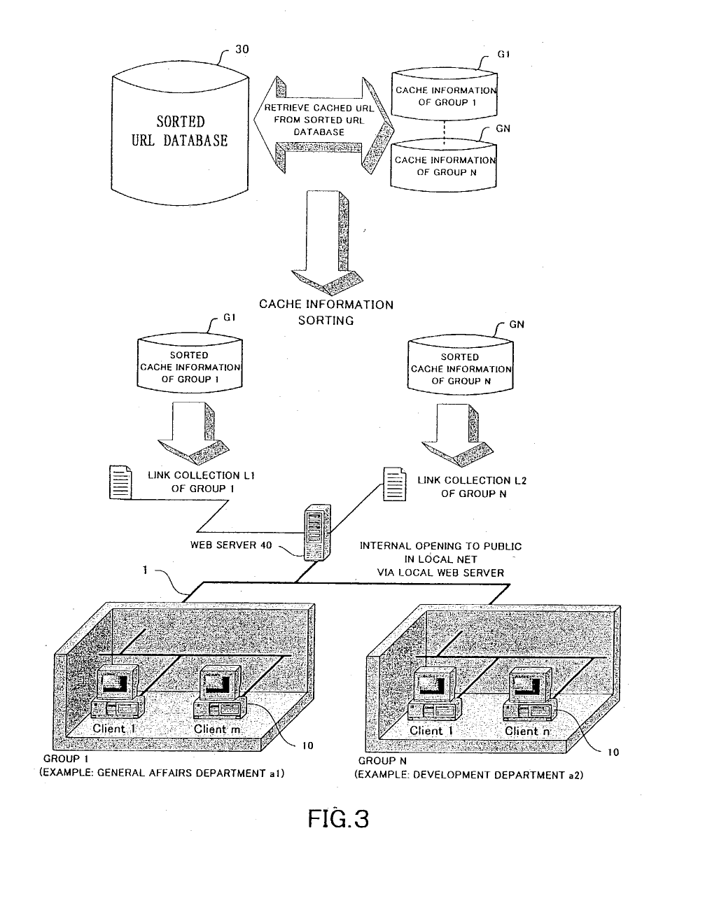

FIG. 3 schematically shows a flow ranging from sorting cache information of each group into categories and generating the link collection to internally opening the link collection to the public via a local web server. A URL database 30 shown in FIG. 3 is a database obtained by sorting URL information groups of web sites existing in the whole world into predetermined categories, such as software development, programs, accounting, politics, IT markets, economics and employment, and storing the URL information groups. The URL of the web site and sorting codes indicating the category are associated and registered. The cache information sorting means 23 acquires the sorting code of the URL from the URL database 30 by the use of the URL of the cached information as the key, and sorts cache information G1 to GN respectively of the groups 1 to N according to sorting codes.

The link collection generation means 24 generates link collections L1 to LN of respective groups on the basis of cache information G1 to GN of respective groups sorted according to sorting codes, and internally opens the link collection of the group to the public in the local net via a local web server 40. The series of processing is executed periodically at predetermined intervals, or executed each time access to the web site is conducted a predetermined number of times or at the time of display operation of the URL link collection. And the latest information is displayed.

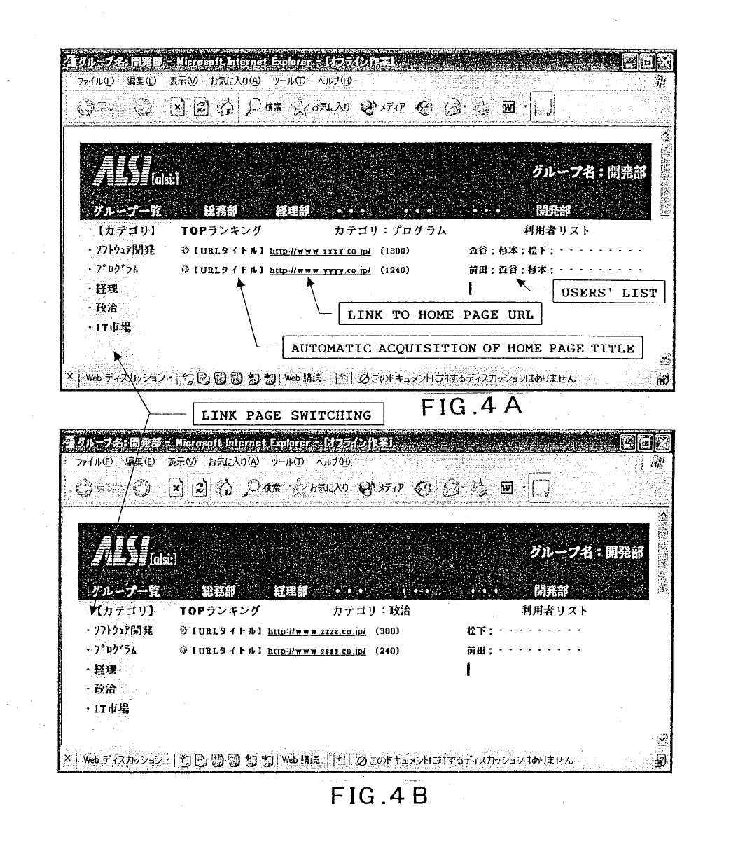

FIGS. 4A and 4B are diagrams showing a first display example of an automatically generated URL link collection. FIG. 4A shows a display example (in the case of Japanese) of a URL link collection in which the category is “program” and FIG. 4B shows a display example (in the case of Japanese) of a URL link collection in which the category is “politics.” As shown in FIGS. 4A and 4B, a group name of a group the client belongs to, a list of groups set so as to be able to be read from the group, a list of cached URL categories, and a URL link collection corresponding to a current category (category=“program” in FIG. 4A) are displayed on predetermined regions of a picture of the client 10 side. In the present example, information of a title of URL, link information to the URL, the number of accessing to the URL, a user list showing a list of users who have utilized the URL (for example, a list of users in order of decreasing number of times of access to the URL) is handled as one item of the URL link collection as illustrated. URL link information pieces belonging to the category are arranged in order of decreasing number of times in use in the group and displayed on the picture of the client 10 side.

When the URL database 30 is used, URLs of web sites which are large in the number of times of utilization in the group are thus ranked for respective categories and displayed as the URL list. By selecting a desired URL from the URL list of the group, the user can access a desired web page. Furthermore, by clicking a desired category in the category list on the picture, the picture of the link collection of the category is switched and displayed. In this way, the URL link collection is displayed so that the page of each category may be switched.

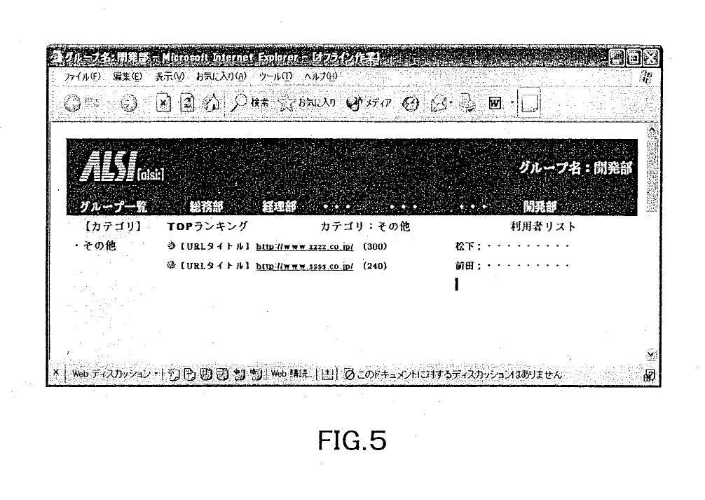

FIG. 5 shows a second display example (in the case of Japanese) of the automatically generated URL link collection. It is a display example in the case where the URL database 30 is not used. In the case where the URL database 30 is not used, the cache information sorting means 23 sorts all categories of the cache information as “the rest” as shown in FIG. 5. The link collection generation means 24 generates a link collection by taking all cache information of the group as the subject, and displays the URL link collection of the group as shown in FIG. 5. In the present example, all cache information belongs to the category of “the rest.” Therefore, URL information of web sites that are large in number of times of utilization in the group is ranked in the whole URL and displayed.

Another example of a URL information sharing system according to the present invention will now be described. In the embodiment described, the URL link collection of each group and the URL link collection of each category are automatically generated by the use of the cache information of the proxy server 20 as the input source data. It is made possible for respective clients or a specific client of the group to use the URL link collection. In this way, URL information is shared by utilizing the cache information. By using the proxy log (log information of the proxy server 20) instead of the cache information as the input source data, similar sharing can be conducted. Hereafter, a URL information sharing system using the proxy log will be described.

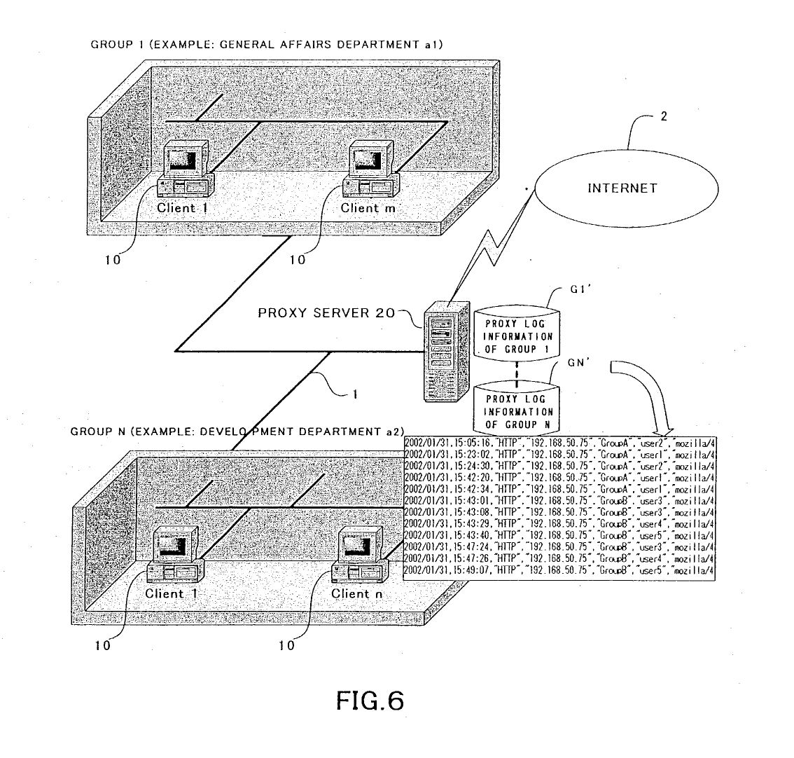

FIGS. 6 to 8 respectively show an example of a whole configuration of the URL information sharing system using proxy log, a configuration example of a principal part, and processing of the URL information sharing system, so as to correspond to FIGS. 1 to 3. The same components as those of the URL information sharing system using proxy cache shown in FIGS. 1 to 3 are denoted by the same characters and description thereof will be omitted. Hereafter, different portions will be described.

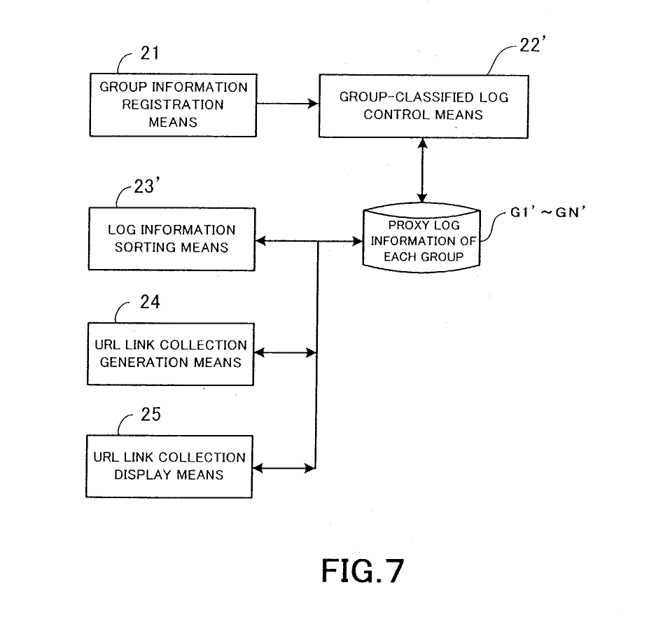

As shown in FIG. 6, in the present embodiment, recording of access history information (hereinafter referred to as proxy log) of the web page is controlled for each of groups 1 to N of registered clients 10. Proxy logs G1′ to GN′ respectively of the groups 1 to N may be generated by inputting proxy logs once recorded and sorting the proxy logs according to group IDs (such as “Group A” and “Group B”) contained in proxy logs. At the time of recording, the proxy logs may be recorded in a file of the group. By the way, the information of the proxy log is access history information such as the access date and time, URL information, and transfer data size. In the present embodiment, a group ID for specifying the group is added and recorded. As shown in FIG. 7, the configuration of the URL information sharing system is implemented by replacing the group-classified cache control means 22 with “group-classified log control means 22”, the cache information sorting means 23 with “log information sorting means 23′”, and processing log information instead of the cache information. In the group-classified log control means 22′, both the proxy cache and the proxy log may be controlled for each group.

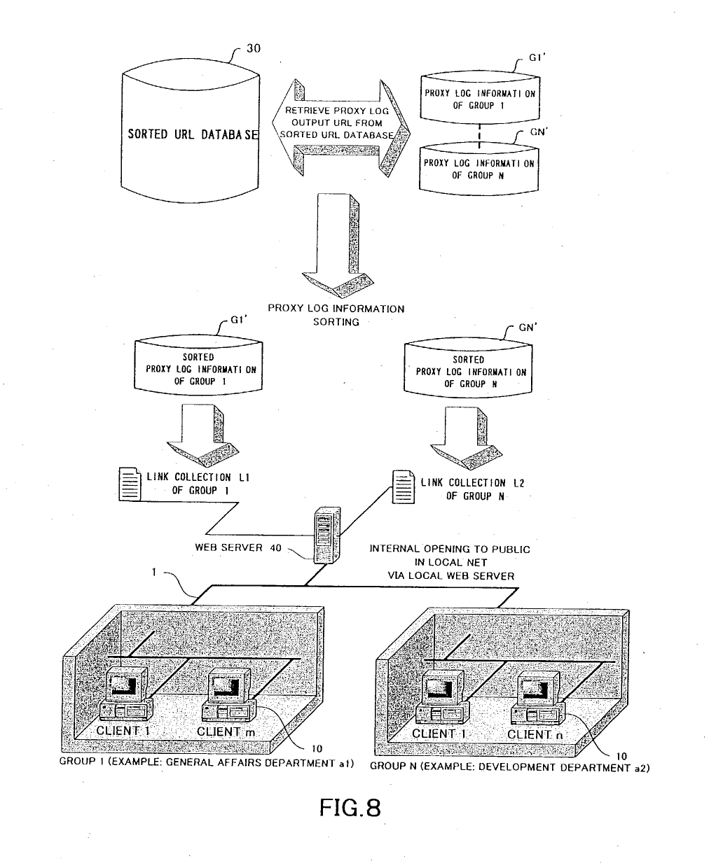

In the above-described configuration, a flow ranging from sorting log information of each group into categories and generating the link collection to internally opening the link collection to the public via a local web server will be described with reference to a schematic diagram shown in FIG. 8.

The log information sorting means 23′ handles the proxy logs G1′ to GN′ recorded from group to group by the group-classified log control means 22′, and acquires the sorting code of the URL from the URL database 30 by the use of the URL as the key, and sorts proxy logs G1′ to GN′ respectively of the groups 1 to N according to sorting codes. The link collection generation means 24 generates link collections L1 to LN of respective groups on the basis of proxy logs G1′ to GN′ of respective groups sorted according to sorting codes. And the link collection generation means 24 internally opens the link collection of the group to the public in the local net via a local web server 40.

In the above-described embodiment, the case where the computer network to which clients 10 are connected is a network in an enterprise and groups are associated with division in registration has been described as an example. However, the type of the internal network and group association are not limited to the present example. For example, the present invention can be preferably applied to a LAN for clients of a specific group, such as intra-school network formed by personal computers of teachers and pupils and a medical information network, and a communication network such as an intranet. Furthermore, the case where grouping is conducted at client terminals has been described as an example. In the case where grouping is conducted by the use of identifiers (user accounts in the present example) specifying client users, however, cache or log control for each user group is conducted. Even when different client terminals are used, the access situation of the user can be grasped.

According to the present invention, caches or logs can be controlled every arbitrary registered client group. Furthermore, it becomes possible to unitarily conduct automatic collection of URL information used in the group every group by utilizing the data of the proxy server. In addition, by automatically generating the link collection to web pages utilized in the group and a users' list and opening them to the public, it becomes possible to share the URL information needed in the group and conduct self-imposed control on reading of information causing a harmful influence. Furthermore, by displaying the URL link collection of the group every category, it becomes possible to know the information needed in the group easily and quickly.

What is claimed is:

1. In a system in which a client terminal connected to an internal network accesses a web site on the Internet via a proxy server having a cache function, a URL information sharing system using a proxy cache or a proxy log, comprising:
registration means for registering group configuration information which indicates association relations between cache or log control MEANS group in the proxy server and client terminals or terminal users, with respect to client terminals connected to the internal network; and
group-classified cache/log control means for controlling a URL information a cache or a log with respect to the web site every group on the basis of the group configuration information.

2. The URL information sharing system using the proxy cache or the proxy log according to claim 1, further comprising:
URL link collection generation means for generating a URL link collection every group by the use of cache information or log information created every group; and
URL link collection display means for displaying the link collection generated every group so that respective clients or a specific client of the group may use the link collection.

3. The URL information sharing system using the proxy cache or the proxy log according to claim 2, further comprising:
a web server for opening the URL link collection of each group to the public by the use of the link collection display means,
wherein information of the URL link collection can be shared by respective client terminals via the web server.

4. The URL information sharing system using the proxy cache or the proxy log according to claim 2, wherein URL link information pieces are arranged in order of decreasing number of times of use in the group and the URL link collection is displayed.

5. The URL information sharing system using the proxy cache or the proxy log according to claim 2, wherein the link collection display means displays a users' list showing a list of users who have utilized the URL, as additional information.

6. The URL information sharing system using the proxy cache or the proxy log according to claim 2, further comprising:
a database for storing a URL information group obtained by sorting URL information of each web site on the Internet according to predetermined categories; and
cache/log information sorting means for sorting cache information or log information created for each group, according to the categories,
wherein the link collection display means displays the URL link collection of the group from category to category.

7. The URL information sharing system using the proxy cache or the proxy log according to claim 1, wherein in the case of a registration form in which association relation with the group is registered by means of the terminal user, registration is conducted by the use of a user account that indicates the terminal user.

8. The URL information sharing system using the proxy cache or the proxy log according to claim 2, wherein
the URL link collection generation means generates the URL link collection by adding access information that indicates when, how many times, who has accessed the URL for reading, and
the link collection display means displays the access information so as to be able to be read from respective clients or a specific client of the group.
